(19) United States
(12) Patent Application Publication
(10) Pub. No.: US 2014/0325424 A1
(43) Pub. Date: Oct. 30, 2014

(54) AUDIO PLAYING DEVICE AND METHOD FOR ADJUSTING PROGRESS BAR

(71) Applicant: HON HAI PRECISION INDUSTRY CO., LTD., New Taipei (TW)

(72) Inventor: HO-LEUNG CHEUNG, Santa Clara, CA (US)

(73) Assignee: HON HAI PRECISION INDUSTRY CO., LTD., New Taipei (TW)

(21) Appl. No.: 14/014,407

(22) Filed: Aug. 30, 2013

(30) Foreign Application Priority Data
Apr. 24, 2013 (TW) 102114713

(51) Int. Cl. G06F 3/0484

(52) U.S. Cl. CPC G06F 3/04847
USPC 715/772

(57) ABSTRACT

A method for adjusting a progress bar includes steps: detecting whether the progress bar is touched by a touch operation, if yes, detecting whether duration of the touch operation on the progress bar exceeds a predetermined time, if yes, determining a first time point, hiding the progress bar, displaying a sub progress bar, determining a second time point which is touched by the touch operation on the sub progress bar, hiding the sub progress bar and displaying the progress bar after the second time point is determined; and adjusting the progress indicator from the first time point to the second time point on the progress bar. A system and an audio playing device for adjusting a progress bar are also provided.

### BACKGROUND

1. Technical Field

The present disclosure relates to audio playing devices, and particularly to an audio playing device, a system and a method for adjusting a progress bar.

2. Description of Related Art

A progress bar normally includes a progress indicator and a number of time points. User usually drags the progress indicator among the number of time points on the progress bar to adjust a playing progress. However, the dragging manner can only achieve a coarse adjustment for the playing progress, and cannot achieve a fine adjustment for the playing progress.

Therefore, what is needed is an audio playing device to overcome the above described limitations.

### BRIEF DESCRIPTION OF THE DRAWING

FIG. 1 is a block diagram of a system for adjusting a progress bar in accordance with an exemplary embodiment.

FIGS. 2-5 show an example for adjusting the progress bar.

FIG. 6 is a flowchart of a progress bar adjusting method implemented by the system of FIG. 1.

### DETAILED DESCRIPTION

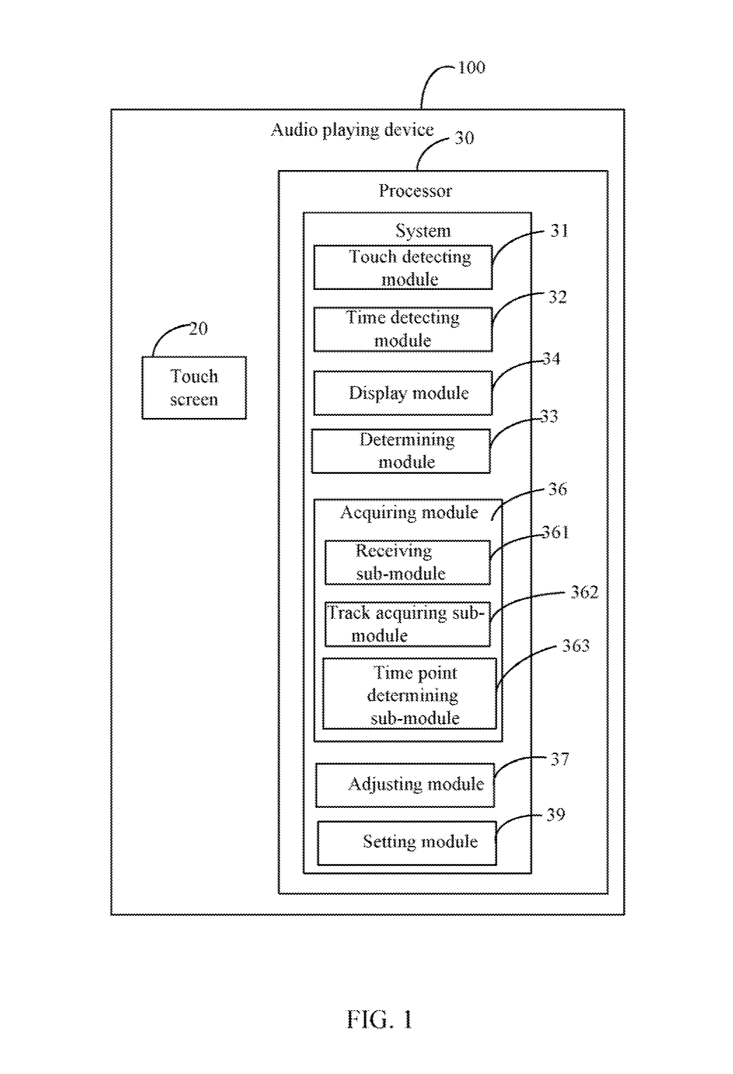

FIG. 1 shows a system 200 for adjusting a progress bar 2. The system 200 runs in an audio playing device 100. The progress bar 2 includes a progress indicator 21 and a number of time points. The audio playing device 100 plays an audio from a time point which is indicated by the progress indicator 21. The audio playing device 100 includes a touch screen 20. The touch screen 20 receives touch operations, such as sliding operation etc. In one embodiment, the audio playing device 100 may be a phone, MP3, or MP4, for example.

The audio playing device 100 includes a processor 30. The processor 30 includes a touch detecting module 31, a time detecting module 32, a determining module 33, a display module 34, an acquiring module 36, and an adjusting module 37 which are collection of software instructions and executed by the processor 30.

The touch detecting module 31 detects whether or not the progress bar 2 is touched by a touch operation. The time detecting module 32 detects whether or not duration of the touch operation on the progress bar 2 exceeds a predetermined time when the progress bar 2 is touched by the touch operation. The determining module 33 determines a first time point on the progress bar 2, hides the progress bar 2, and displays a sub progress bar 3 when the duration of the touch operation on the progress bar 2 exceeds the predetermined time. The sub progress bar 3 includes a beginning time point and an ending time point. The beginning time point is the first time point. The ending time point is obtained by adding a predetermined time period to the first time point. The ending time point on the sub progress bar 3 is less than an ending time point on the progress bar 2. In one embodiment, the determining module 33 can display the sub progress bar 3 in a position where the bar has progressed, or display the sub progress bar 3 in other positions. The acquiring module 36 further determines a second time point which is touched by the touch operation on the sub progress bar 3. The determining module 33 further hides the sub progress bar 3 and displays the progress bar 2 after the second time point is determined The adjusting module 37 adjusts the progress indicator 21 from the first time point to the second time point on the progress bar 2.

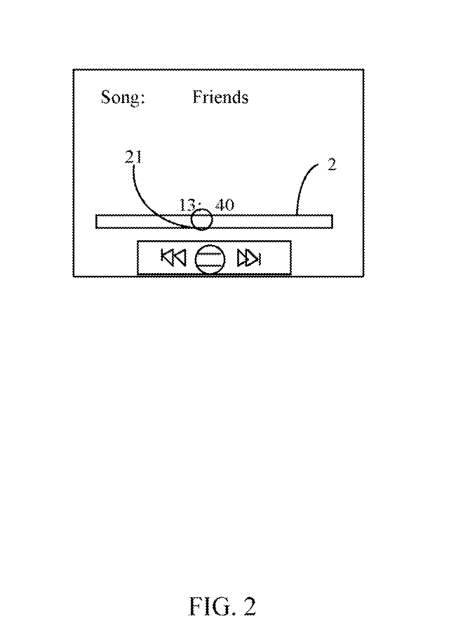

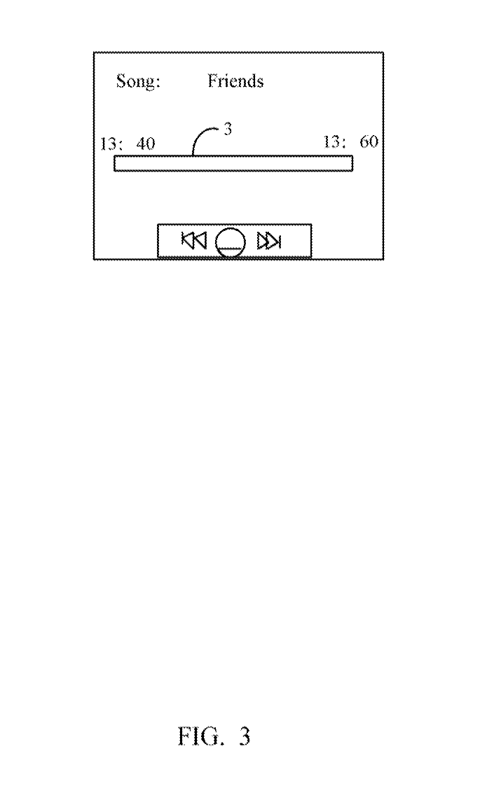

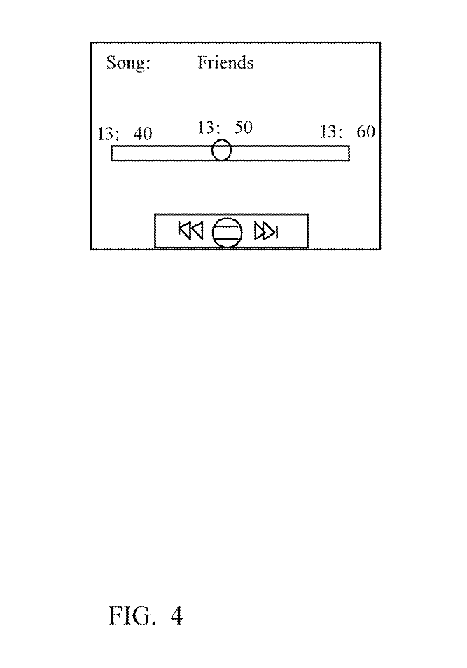

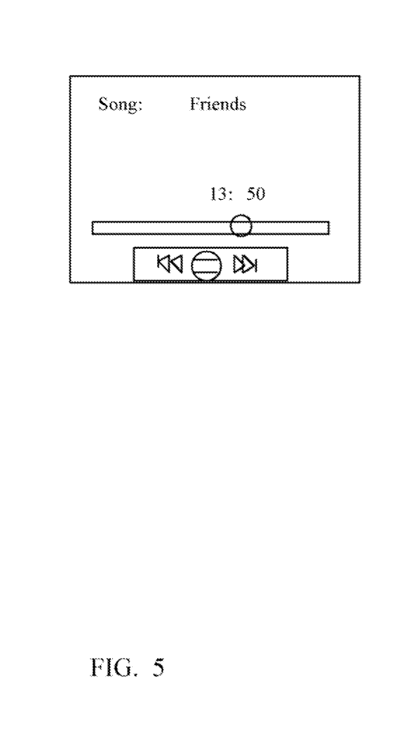

FIGS. 2-5 show that there is an audio file being played, when the user touches a time point 13:40 on the progress bar 2 for a duration exceeding the predetermined time, the audio playing device 100 displays a sub progress bar 3. The beginning time point of the sub progress bar 3 is 13:40, and the ending time point of the sub progress bar 3 is obtained by adding the predetermined time period, e.g., 00:20, to the time point 13:40, that is, the ending time point of the sub progress bar 3 is 13:60. When the user touches a time point 13:50 on the sub progress bar 3, the audio playing device 100 adjusts the progress indicator 21 from the time point 13:40 to the time point 13:50 on the progress bar 2, and hides the sub progress bar 3, thereby achieving a fine adjustment for the progress bar 2.

In one embodiment, the display module 34 further displays the progress bar 2 after the progress indicator 21 is adjusted in response to a user operation.

In one embodiment, the acquiring module 36 includes a receiving sub-module 361, a track acquiring sub-module 362, and a time point acquiring sub-module 363. The receiving sub-module 361 receives a sliding operation from the first time point on the sub progress bar 3. The track acquiring sub-module 362 acquire a sliding track of the sliding operation. The time point determining sub-module 363 determines the second time point based on the sliding track on the sub progress bar 3.

The processor 30 further includes a setting module 39. The setting module 39 sets the predetermined time and the predetermined time period in response to the user operation.

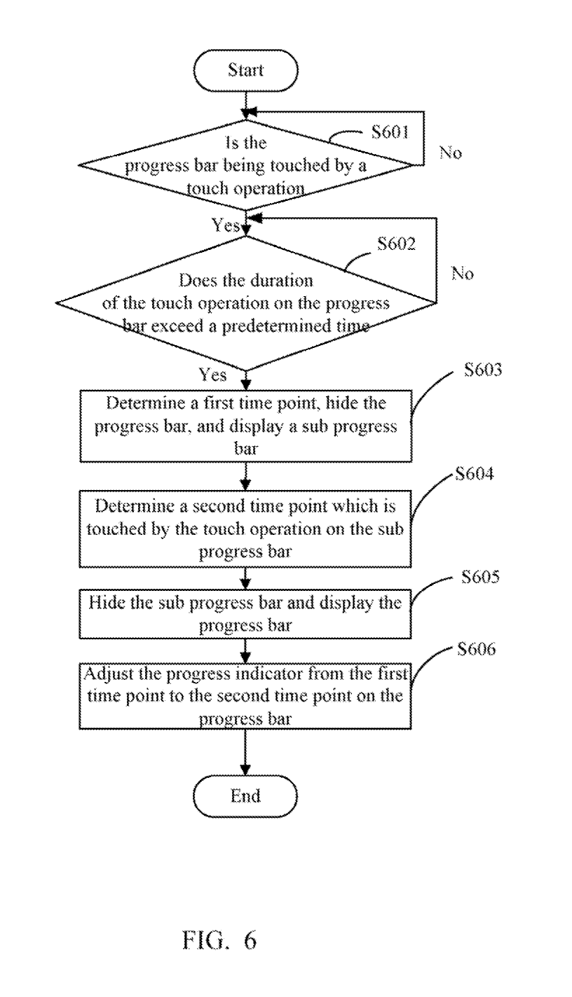

FIG. 6 is a flowchart of a progress bar adjusting method implemented by the system of FIG. 1.

In step S601, the touch detecting module 31 detects whether or not the progress bar 2 is touched by a touch operation, if yes, the procedure goes to step S602, if no, the procedure goes to step S601.

In step S602, the time detecting module 32 detects whether or not a duration of the touch operation on the progress bar 2 exceeds a predetermined time, if yes, the procedure goes to step S603, if no, the procedure goes to step S602.

In step S603, the determining module 33 determines a first time point on the progress bar, hides the progress bar 2, and displays a sub progress bar 3.

In step S604, the acquiring module 36 determines a second time point which is touched by the touch operation on the sub progress bar 3.

In step S605, determining module 33 hides the sub progress bar 3 and displays the progress bar 2.

In step S606, the adjusting module 37 adjusts the progress indicator 21 from the first time point to the second time point on the progress bar 2.

The method further includes a sub-step: the setting module 39 setting the predetermined time and the predetermined time period of the time in response to the user operation.

Although various embodiments have been specifically described, the disclosure is not to be construed as being limited thereto. Various changes or modifications may be made to the embodiments without departing from the scope and spirit of the disclosure.

What is claimed is:

1. A system for adjusting a progress bar which comprises a progress indicator and a plurality of time points, wherein the system runs in an audio playing device, the audio playing device comprises a touch screen for receiving touch operations, the system comprising:
one or more processors; and
a plurality of modules to be executed by the one or more processors, wherein the plurality of modules comprises:
a touch detecting module configured to detect whether or not the progress bar is touched by a touch operation;
a time detecting module configured to detect whether or not duration of the touch operation on the progress bar exceeds a predetermined time when the progress bar is touched by the touch operation;
a determining module configured to determine a first time point on the progress bar, hide the progress bar, and display a sub progress bar, when the duration of the touch operation on the progress bar exceeds the predetermined time; wherein the sub progress bar comprises a beginning time and an ending time, the beginning time is the first time point, the ending time is obtained by adding a predetermined time period to the first time point;
an acquiring module further configured to determine a second time point which is touched by the touch operation on the sub progress bar;
the determining module further configured to hide the sub progress bar and display the progress bar once the second time point is determined; and
an adjusting module configured to adjust the progress indicator from the first time point to the second time point on the progress bar.

2. The system as described in claim 1, wherein the acquiring module comprises a receiving sub-module, a track acquiring sub-module, and a time point acquiring sub-module, the receiving sub-module is configured to receive a sliding operation from the first time point on the sub progress bar, the track acquiring sub-module is configured to acquire a sliding track of the sliding operation, the time point determining sub-module is configured to determine the second time point based on the sliding track on the sub progress bar.

3. The system as described in claim 1, wherein the plurality of modules further comprises a setting module configured to set the predetermined time and the predetermined time period in response to the user operation.

4. An audio playing device for adjusting a progress bar which comprises a progress indicator and a plurality of time points, the audio playing device comprising:
a touch screen for receiving touch operations; and
a processor configured to detect whether or not the progress bar is touched by a touch operation, detect whether or not duration of the touch operation on the progress bar exceeds a predetermined time when the progress bar is touched by the touch operation, determine a first time point on the progress bar, hide the progress bar, and display a sun progress bar when the duration of the touch operation on the progress bar exceeds the predetermined time, wherein the sub progress bar comprises a beginning time and an ending time, the beginning time is the first time point, the ending time is obtained by adding a predetermined time period to the first time point, determine a second time point which is touched by the touch operation on the sub progress bar, hide the sub progress bar and display the progress bar after the second time point is determined, and adjust the progress indicator from the first time point to the second time point on the progress bar.

5. The audio playing device as described in claim 4, wherein the processor is configured to receive a sliding operation from the first time point on the sub progress bar, acquire a sliding track of the sliding operation, and determine the second time point based on the sliding track on the sub progress bar.

6. The audio playing device as described in claim 4, wherein the processor is configured to set the predetermined time and the predetermined time period in response to the user operation.

7. A method for adjusting a progress bar implemented by an audio playing device, wherein the progress bar comprises a progress indicator and a plurality of time points, the audio playing device comprises a touch screen for receiving touch operations, the method comprising:
detecting whether or not the progress bar is touched by a touch operation;
detecting whether or not duration of the touch operation on the progress bar exceeds a predetermined time when the progress bar is touched by the touch operation;
determining a first time point on the progress bar, hiding the progress bar, and displaying a sub progress bar, when the duration of the touch operation on the progress bar exceeds the predetermined time; wherein the sub progress bar comprises a beginning time and an ending time, the beginning time is the first time point, the ending time is obtained by adding a predetermined time period to the first time point;
determining a second time point which is touched by the touch operation on the sub progress bar;
hiding the sub progress bar and displaying the progress bar once the second time point is determined; and
adjusting the progress indicator from the first time point to the second time point on the progress bar.

8. The method as described in claim 7, further comprising:
receiving a sliding operation from the first time point on the sub progress bar;
acquiring a sliding track of the sliding operation; and
determining the second time point based on the sliding track on the sub progress bar.

9. The method as described in claim 7, further comprising:
setting the predetermined time and the predetermined time period in response to the user operation.
